(19) United States
(12) Patent Application Publication
(10) Pub. No.: US 2025/0124732 A1
(43) Pub. Date: Apr. 17, 2025

(54) EXTRACTION OF BORDERLESS TABLE FROM A DOCUMENT USING IMAGE PROCESSING

(71) Applicant: L&T TECHNOLOGY SERVICES LIMITED, Chennai (IN)

(72) Inventors: TARUN KUMAR DAS, Digboi (IN); TRIPTESH MALLICK, Bankura (IN); MRIDUL BALARAMAN, Bangalore (IN); MADHUSUDAN SINGH, Bangalore (IN)

(21) Appl. No.: 18/544,484

(22) PCT Filed: Aug. 2, 2022
(86) PCT No.: PCT/IB2022/057153

§ 371 Date: Dec. 19, 2023

(30) Foreign Application Priority Data
Nov. 22, 2021 (IN) 202141053505

(51) Int. Cl. G06V 30/414; G06V 30/14; G06V 30/19

(52) U.S. Cl. CPC G06V 30/414; G06V 30/1444; G06V 30/19107

(57) ABSTRACT

A method and system of extracting borderless structure using image processing is disclosed. The method may include converting a received document into a binary image comprising a plurality of text characters. A first image is created comprising a plurality of text blobs by connecting text characters and merging the plurality of text blobs to create one or more text line blobs to generate a second image. Further the first image and the second image are compared to generate a third image comprising a plurality of gap blobs. The gap blobs are clustered into one or more groups to determine a localized region of interest (ROI). Further lines are identified within the ROI using pixel density and separated into rows and columns. The final output contains list of cell coordinates.

### TECHNICAL FIELD

This disclosure relates generally to image processing, and more particularly to extraction of borderless structure from a document using image processing techniques.

### BACKGROUND OF THE INVENTION

Documents may include various characters which may be included in different formats and structures such as tables, paragraphs, etc. This may be done to communicate, in a compact manner, important information effectively. The structures may have varying layouts and positions, due to which it is challenging to design generic algorithms to detect and extract information from such documents. For example, the structures may or may not have defined borders and the structure cells may or may not be clearly separated from each other. This makes the process of extracting data from these documents further challenging. Existing Optical Character Recognition (OCR) techniques for extracting textual data either assume a standard document and layout or use heuristics to detect the structure in documents. However, this limits their capabilities and accuracy.

Therefore, there is a need for a method of identifying structures in a document and outputting the textual information in a structured form that is usable for further processing.

### SUMMARY OF THE INVENTION

In an embodiment, a method of extracting borderless structure from a document is disclosed. The document received may be converted into a binary image, wherein the document comprises a plurality of text characters in a plurality of text lines. Converting may include changing the color of the background to black color and changing the color of the foreground to white color. A first image may be created including a plurality of text characters regions, wherein the plurality of text character regions are generated by connecting one or more consecutive text characters within a text line of the plurality of text lines, using at least one morphological operation.

A second image may be created by merging the plurality of text character regions to create one or more text line regions based on coordinates of the text character regions corresponding to a text line from the plurality of text lines and based on a pre-defined inter-text region distance. The first image and the second image may be compared to identify one or more gap regions between the text character regions and the text line regions. The identified one or more gap regions may be clustered based on a clustering criterion to create one or more regions of interest (ROIs). Each of the one or more ROIs may be enclosed using a plurality of horizontal structure lines and a plurality of vertical structure lines based on pixel density of a background, a number of text lines in each of the one or more ROIs, and size of each of the one or more ROIs. The output contains the information of each cell of rows and columns created by the process in a list. Accordingly, an output list of coordinates is generated of one or more cells generated using the plurality of horizontal structure lines and the plurality of vertical structure lines which enclose each of the one or more ROIs.

In another embodiment, a system for extracting a borderless structure from a document is disclosed. The system may include one or more processors communicably connected to a memory, wherein the memory stores a plurality of processor-executable instructions, which, upon execution, cause the processor to convert the document into a binary image. The document may comprise a plurality of text characters in a plurality of text lines. A first image may be created comprising a plurality of text character regions, wherein the plurality of text character regions are generated by connecting one or more consecutive text characters within a text line of the plurality of text lines, using at least one morphological operation. A second image may be created by merging the plurality of text character regions to create one or more text line regions based on coordinates of the text character regions corresponding to a text line from the plurality of text lines, and based on a pre-defined inter-text region distance. The first image and the second image may then be compared to identify one or more gap regions between the text character regions and the text line regions. The identified one or more gap regions may be then clustered based on a clustering criterion to create one or more regions of interest (ROIs). Each of the one or more ROIs may be enclosed using a plurality of horizontal structure lines and a plurality of vertical structure lines based on pixel density of a background, a number of text lines in each of the one or more ROIs, and size of each of the one or more ROIs. The output contains the information of each cell of rows and columns created by the process in a list. Accordingly, an output list of coordinates is generated of one or more cells generated using the plurality of horizontal structure lines and the plurality of vertical structure lines which enclose each of the one or more ROIs.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a process of conversion of multicolor image to binary image, in accordance with an embodiment of the present disclosure.

FIG. 2 illustrates a process of formation of text blobs, in accordance with an embodiment of the present disclosure.

FIG. 3 illustrates a process of merging text blobs to create text line blobs, in accordance with an embodiment of the present disclosure.

FIG. 4 illustrates a process of formation of text line blobs from the text blobs, in accordance with an embodiment of the present disclosure.

FIG. 5 illustrates a process of extraction of inter text gap blobs, in accordance with an embodiment of the present disclosure.

FIG. 6 illustrates a process of indexing and grouping text-lines based on determined gap blobs, in accordance with an embodiment of the present disclosure.

FIG. 7A-B illustrates a process of merging gap blobs vertically, in accordance with an embodiment of the present disclosure.

FIG. 8 illustrates a process of clustering of the plurality of gap blobs for determination of a region of interest (ROI), in accordance with an embodiment of the present disclosure.

FIG. 9 illustrates a process of determination of ROIs, in accordance with an embodiment of the present disclosure.

FIG. 10 illustrates creation of row(s) and column(s) based on ROIs identified, in accordance with an embodiment of the present disclosure.

FIG. 11 illustrates an output image depicting row(s) and column(s) formed within the detected ROI's, in accordance with an embodiment of the present disclosure.

FIG. 12 illustrates a flowchart of a process of extracting borderless table from a document, in accordance with an embodiment of the present disclosure.

FIG. 13 illustrates a flowchart of a method of extracting a borderless structure from a document, in accordance with another embodiment of the present disclosure.

FIG. 14 illustrates a block diagram of an environment for extracting borderless Table from a document, in accordance with an embodiment of the disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are list.

According to an embodiment, a borderless structure is similar to a document Table in which text is projected in a structured manner but lacks any visible lines and boundaries separating the rows and columns. The present disclosure provides techniques which attempts to extract information from the Tables by detecting a region of interest (ROI) within the document using intertext spacing, index grouping of sentence lines which exhibit these inter-text spaces. Moreover, an intertext line spacing is calculated to merge the gap blobs in lined in Y-axis. If conditionally merged, text lines associated is taken into considerations so the rows and columns may be created based on the pixel density of the conditionally merged structure.

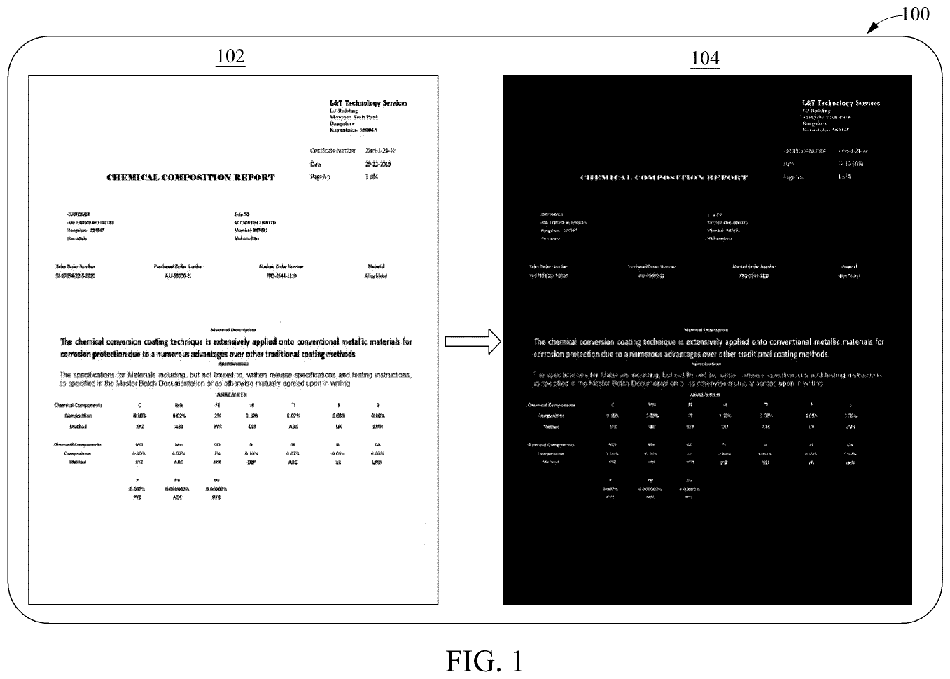

Referring to FIG. 1, a process diagram of a process 100 of conversion of multicolor image to binary image is illustrated, in accordance with an embodiment of the present disclosure. A multicolor image 102 may be received. This multicolor image may be converted to a binary image 104. The binary image 104 is a digital image which may include pixels that can have one of exactly two colors, usually black or white. The pixel information of the original multicolor image 102 is analyzed, and the original multicolor image 102 is converted into a non-color image or binary image 104, i.e. the color of the background may be changed to black color and the color of the foreground may be changed to white color. A statistically calculated height (h_m) and width (w_m) is determined as kernel size value from the characters detected in the binary image. In an embodiment, the character area having dimensions within certain threshold limits of the calculated w_m and h_m may be considered to determine the word blobs and sentence blobs corresponding to different text areas in the binary image.

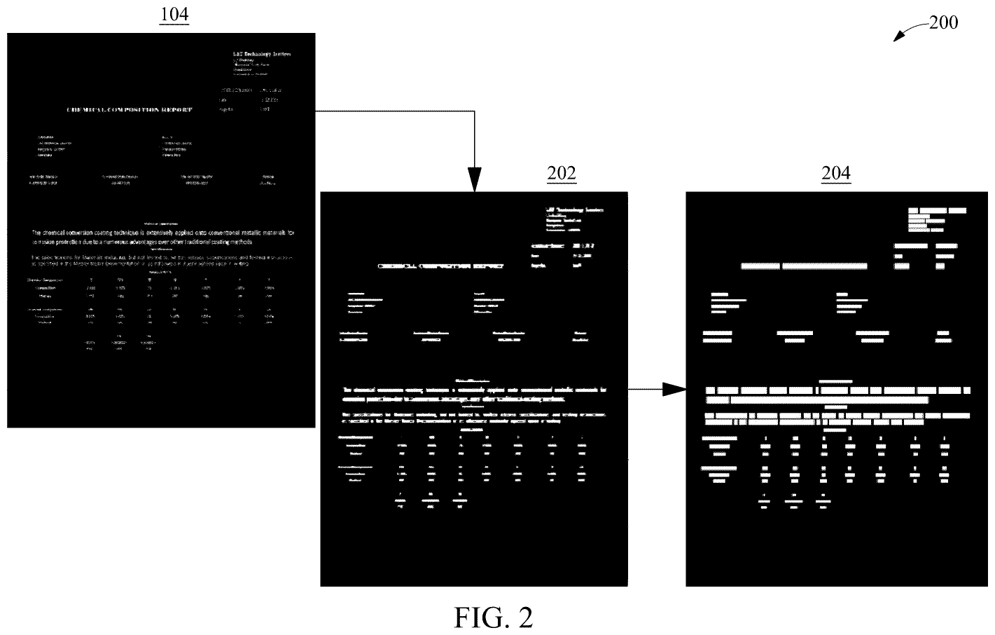

Referring now to FIG. 2, a process diagram of a process 200 of formation of binary large object (blob) which includes text also referred herein as text blobs is illustrated, in accordance with an embodiment of the present disclosure. A kernel size to connect each text character in the binary image may be converted into a blob, in particular a text blob using a kernel size [m×1]. These blobs may be created using an image processing technique. Further, the connected character blobs may be merged to forming rectangular text blobs or text regions. the character blobs (e.g. text characters) may be connected to form text-word blobs. The text-word blobs maybe created by connecting text characters using at least one morphological operation to generate a first image 204, based on kernel size. The kernel size may be represented as: ‘[m×1]’, where ‘m’ is dependent of the width of the characters. For a text-word blob the kernel size may be defined as ‘[m×1]’, considering that the height of the character blobs in a word remains same. In an embodiment, a directory of a list of all text rectangular blobs [x1, y1, x2, y2] may be created.

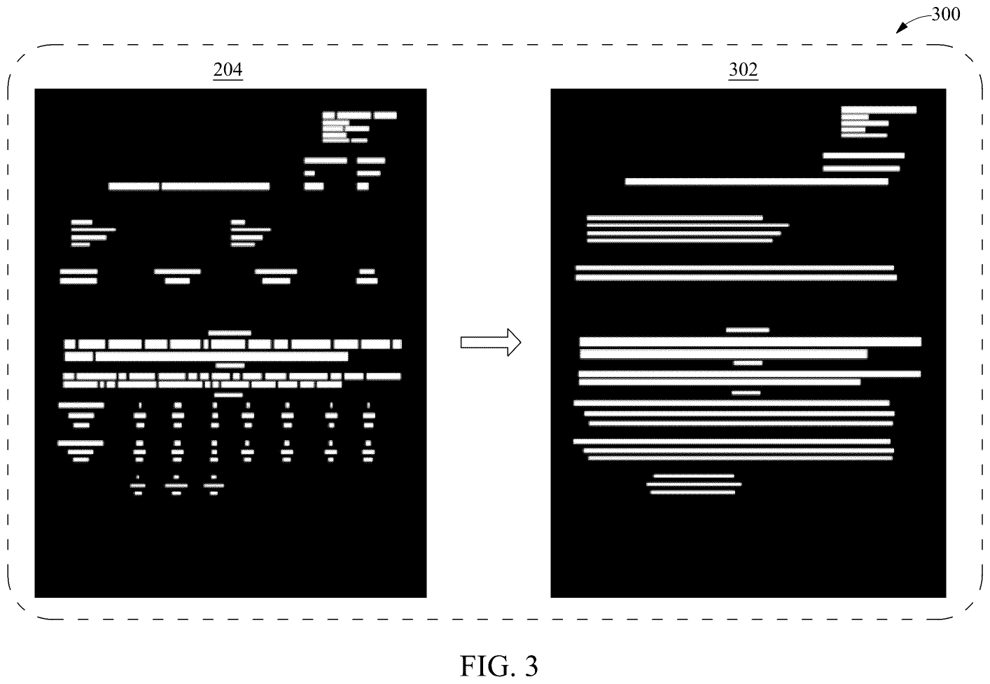

Referring now to FIG. 3, a process diagram of a process 300 of merging text blobs to create text line blobs is illustrated, in accordance with an embodiment of the present disclosure. As shown, the text-line blobs may be created from text-word blobs. The text-word blobs may be merged to create one or more text-line blobs based on coordinates of the text-word blobs to generate a second image 302, in accordance with a process 300 as shown in FIG. 3. This eventually may lead to the formation of rectangular box(es) using image processing.

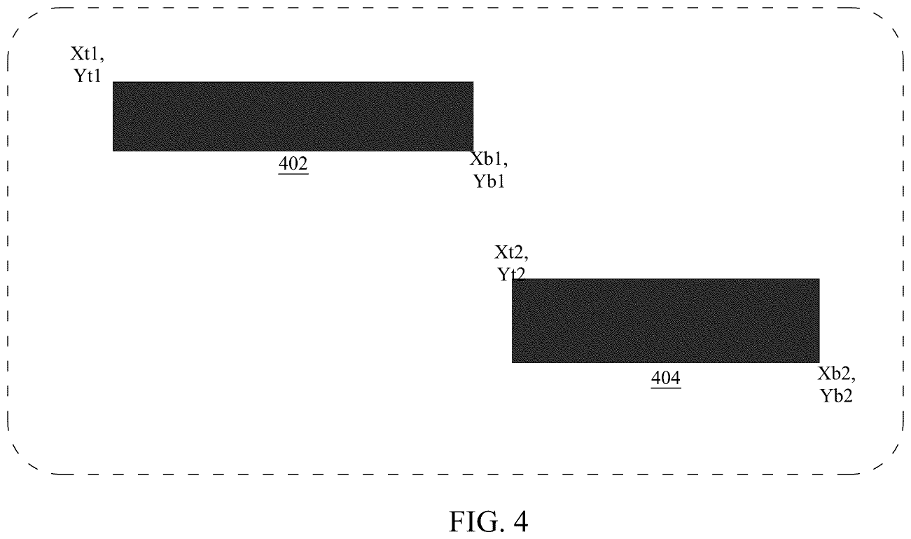

FIG. 4 illustrates a process of formation of text line blobs from text blobs, in accordance with an embodiment of the present disclosure. As shown in the FIG. 4, text blobs are shown as two rectangular box(es) 402 and 404. The text blob 402 may have coordinates (Xt1, Yt1, Xb1, Yb1), where ‘t’ depicts top and ‘b’ depicts bottom.

It should be noted that for any two consecutive words, as represented by the text blobs 402 and 404, to be in the same line, the condition given by equation (Yt1>=Yb2 and Yb1<=Yt2) is to be satisfied, wherein Yt1 depicts top y-coordinates of first text blob, Yb2 depicts bottom y-coordinates of the second text blob, Yb1 depicts bottom y-coordinates of the first text blob and Yt2 depicts top y-coordinates of second text blob. This method is repeated for all consecutive word blobs or text blobs for them to be on a line. Further, all the text blobs which satisfy the above condition are then updated in a list of words on a particular line. Further, the coordinates of that particular line to create a text-line blob are determined based on the coordinates of the text blobs 402 and 404 added to the list based on the condition given by equation—[min(x1), max(y1), max(x2), max(y2)], as referred in [022]. In order to obtain the text-line coordinates the condition is iteratively checked for all the coordinates of the text blobs determined to be on the line.

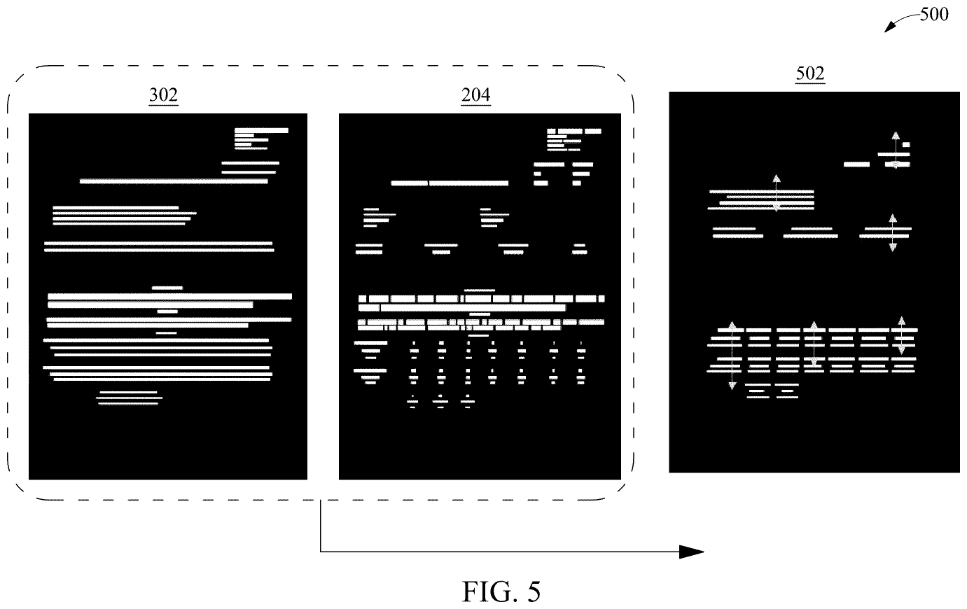

Referring now to FIG. 5, which illustrates a process 500 of extraction of inter text gap blobs, in accordance with an embodiment of the present disclosure. The first image 204 is subtracted from the second image 302 to identify gaps between the blobs and to further generate a third image 502 which may include a plurality of gap blobs or inter text gap blobs. Further, all the small gaps which have an area less or equal to a median width of characters width value (less than 2*w_m) (as referred in paragraph [021]) may not be considered using image processing. In an embodiment, the localized kernel size is evaluated to merge the gap vertically in any inline along Y axis from statistically calculated height using the inter-text line distance. In other words, inter text gap blob may be obtained by subtracting the text word blob from the text sentence blob.

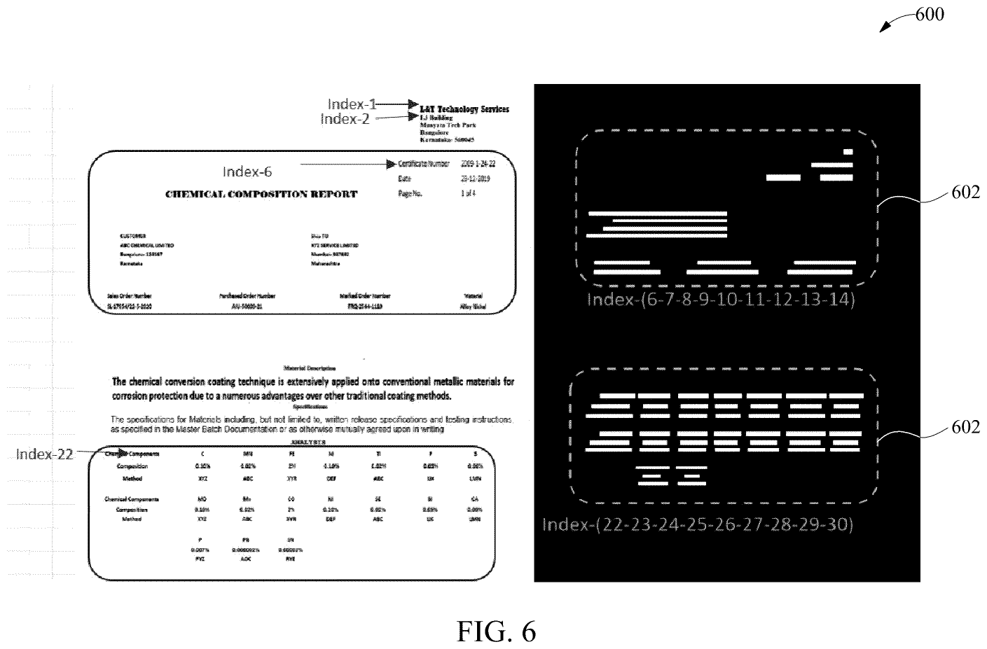

Referring now to FIG. 6, a process of indexing and grouping of gap blob based on the continuity of the corresponding index numbers is illustrated, in accordance with an embodiment of the present disclosure. A serial number index such as Index-1, Index-2 Index-6 and so on may be assigned to each of the one or more text line blobs determined based on their occurrence from top to bottom of the image.

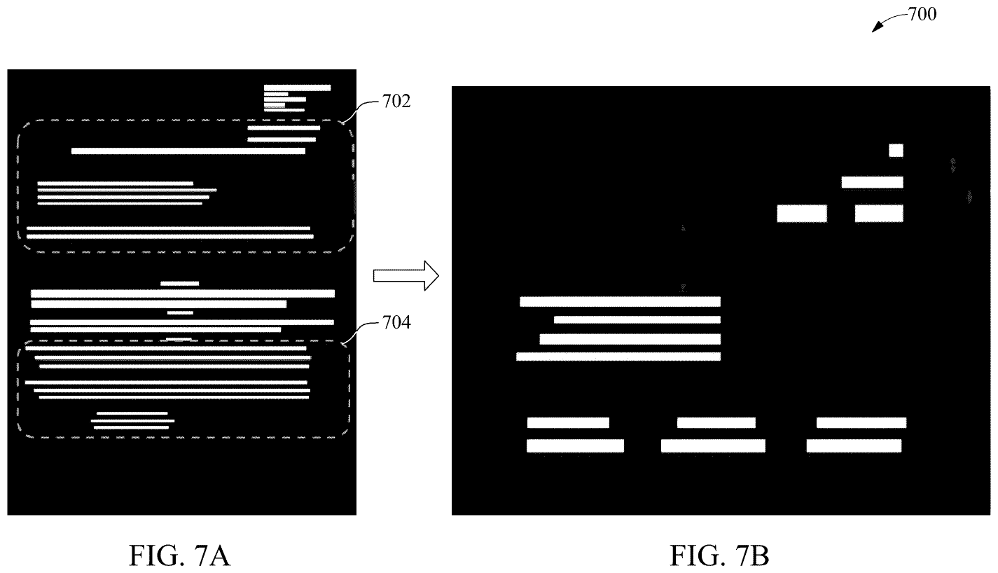

FIGS. 7A-B illustrates a process of merging gap blobs vertically, in accordance with an embodiment of the present disclosure. As shown in FIG. 7A, from the grouped gap blobs, a statistically value ‘h_i’ is calculated from the inter text-line distances and based on it a kernel size “[1×h_i]” is considered for merging the gap blobs in Y-axis. As shown in FIG. 7B, the gap blobs in area 700 are merged vertically based on a value h_i calculated from the inter-text lines exhibit in this area. Accordingly, the process may be done for area 704 and other local areas detected.

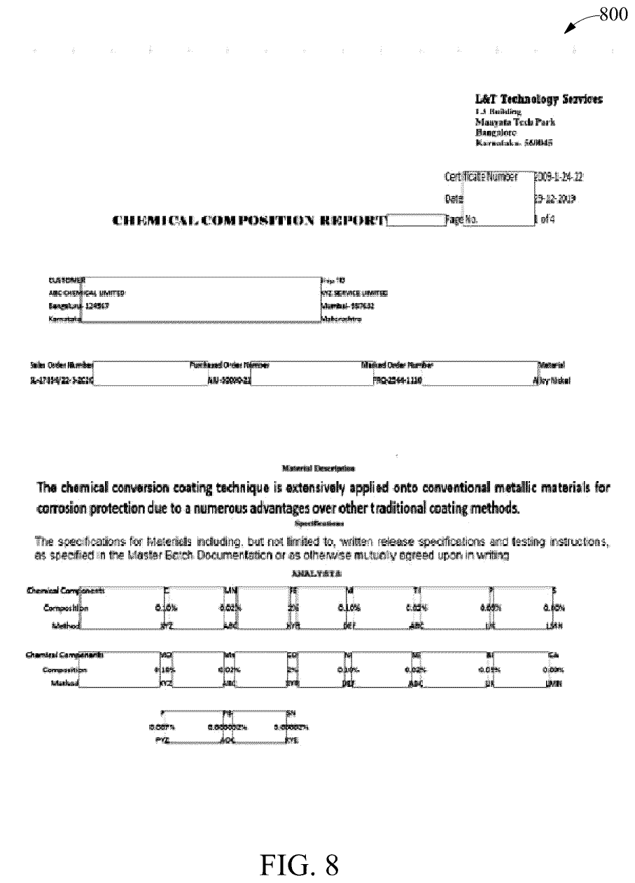

FIG. 8 illustrates a process of clustering of the plurality of gap blobs for determination of a region of interest (ROI), in accordance with an embodiment of the present disclosure. The plurality of gap blobs may be mapped corresponding to the serial number index assigned to each of the one or more text line blobs. The gap blobs may be clustered based on serial index number of each text-line blob and the kernel size “[1×h_i]” evaluated. ROI is determined based on grouping the text line blobs mapped to corresponding gap blobs irrespective of its location and alignment. In an embodiment, a statistically calculated value may be determined and a kernel length is used for merging the gap blob of the ROI if conditionally satisfied. In an embodiment, similar pattern of gap blobs may also be considered for determination of ROI.

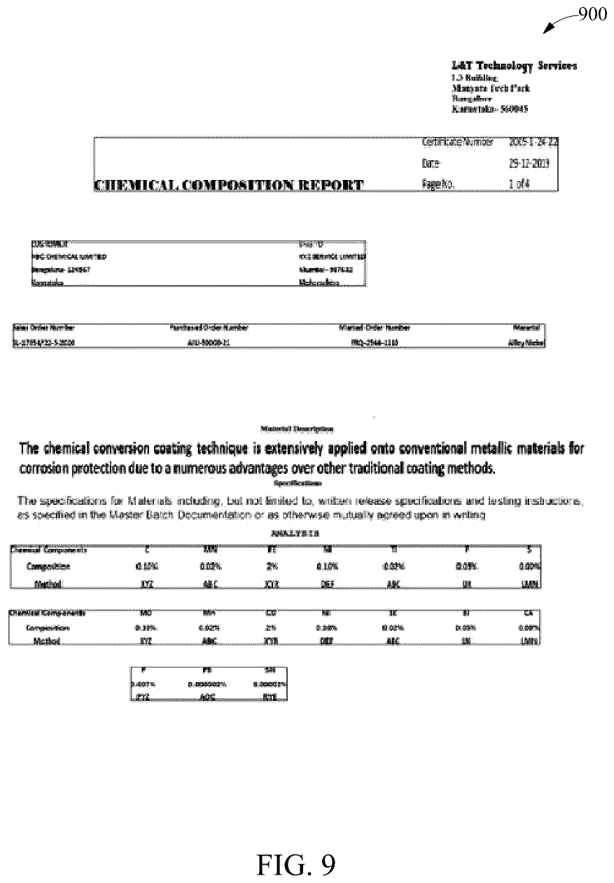

FIG. 9 illustrates a process of determination of ROIs, in accordance with an embodiment of the present disclosure. ROIs in the image may be determined to be a region between the top-most text-line blob to the bottom most text-line blob in the region of conditionally merged gap blobs. Further, a minimum number of lines is pre-defined as threshold that is required within the ROI vertical length. The lines may be generated in both the axes corresponding to the localized ROI based on background density.

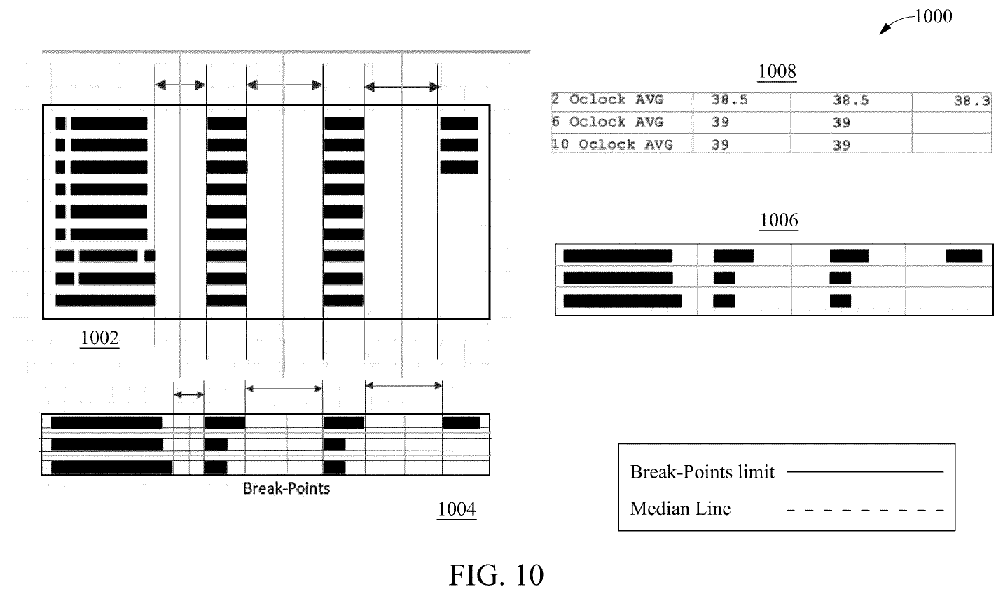

FIG. 10 illustrates creation of rows and columns based on ROIs identified, in accordance with an embodiment of the present disclosure. For each ROI, regions from the text-line blobs 204 are cropped and are used to determine the break points and calculate the median points from it. These median points are used to split rows and columns in ROI. It should be noted that the break points as depicted by solid line may be determined on the basis of the white pixel density from the ROI of text blob image. (For example, if the white pixel density is 0, then the break point is collected, else not). A median value as depicted by broken line, in both horizontal and vertical directions may be generated upon collection of the break point(s). Further, the median line corresponding to the median points evaluated from break points may be generated as final boundary lines in the vertical and horizontal directions for splitting of rows and columns as shown in 1004. Cell coordinates corresponding to each ROI may be generated to provide a list of coordinates . . . .

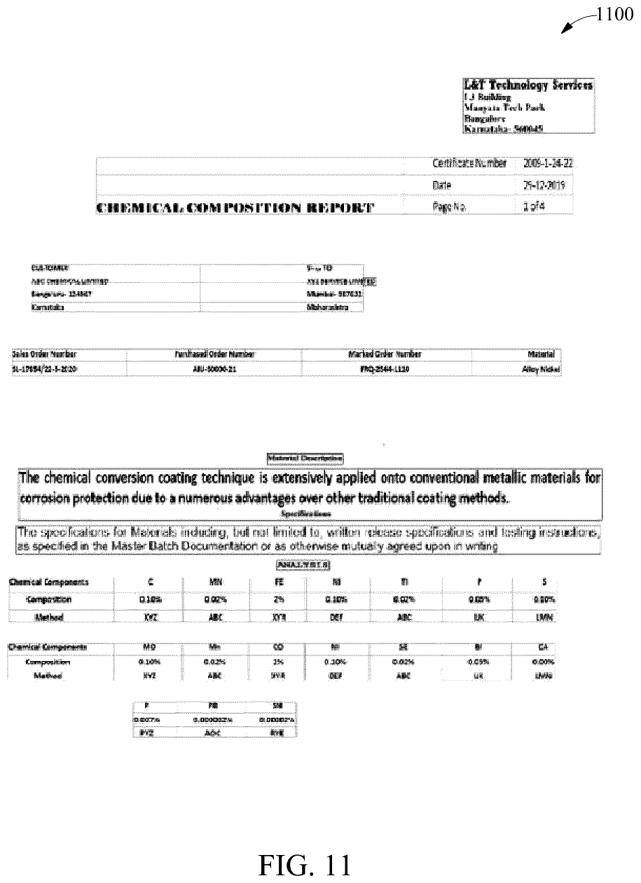

FIG. 11 illustrates an image 1100 depicting the splitting of rows and columns in accordance with an embodiment of the present disclosure. These cells are represented as [x1, y1, x2, y2] contained in list/dataframe format.

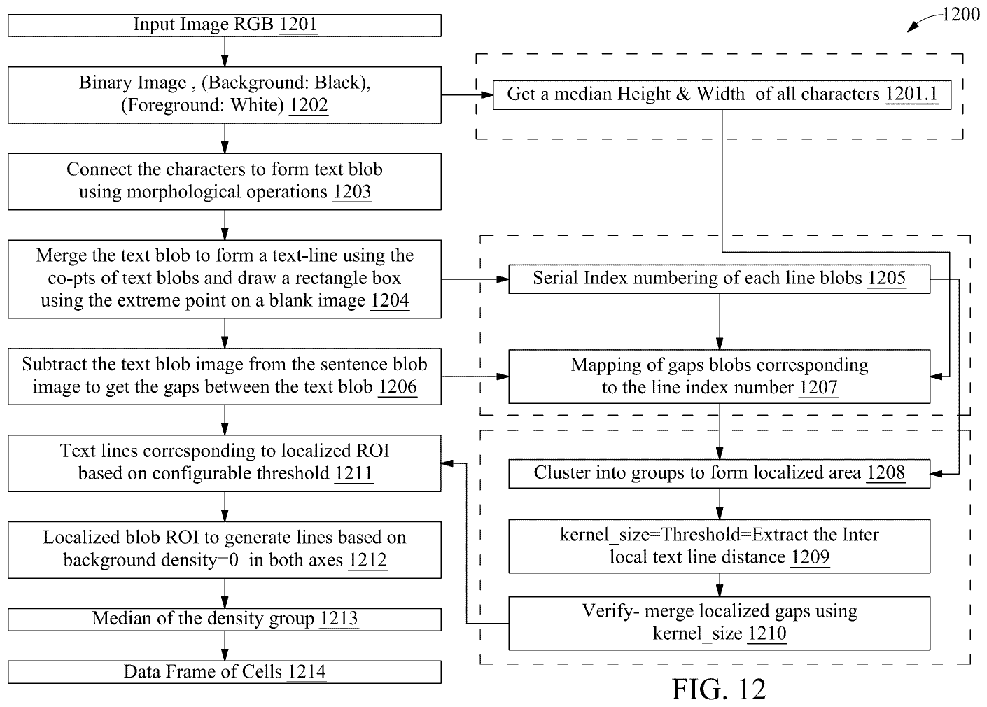

Referring now to FIG. 12, a flowchart of a process 1200 of extracting borderless table from a document is illustrated, in accordance with an embodiment of the present disclosure. At step 1201, a multi-color image (RGB image) may be received as an input. At step 1202, the inputted multi color image may be converted to binary or non-color image. The conversion process may include changing the color of the background to black color and changing the color of the foreground to white color. At step 1202.1, a statistically calculated height and width of all the text characters from the document may be determined.

At step 1203, all the text characters may be connected to form plurality of text blobs in a line using at least one morphological operation to generate a first image. At step 1204, a plurality of text blobs may be merged to create one or more text line blobs based on the coordinates of the text blobs to generate a second image. In order to determine if two text blobs are on the same line a condition given by equation (Yt1>=Yb2 and Yb1<=Yt2) must be satisfied, wherein Yt1 depicts top y-coordinates of first text blob, Yb2 depicts bottom y-coordinates of the second text blob, Yb1 depicts bottom y-coordinates of the first text blob and Yt2 depicts top y-coordinates of second text blob. It may also include formation of a text-line blob in shape of a he rectangular box by using the extreme coordinates of all the text blobs determined on a line based on condition given by equation—[min(x1), max(y1), max(x2), max(y2)]. Thus, extreme coordinates of the text blobs from the text blobs if conditionally merged are utilized to determine the coordinates of the text line. At step 1205, a serial number index may be assigned to each of the one or more text line blobs starting from the top of the input image. At step 1206, the first image and the second image may be compared to identify gaps between the text blobs and to further generate a third image comprising a plurality of gap blobs or plurality of inter text gap blobs. In addition, all the small gaps (gaps with text width value less than 2*w_m) may be removed using image processing methods.

At step 1207, each of the plurality of gap blobs may be mapped corresponding to the serial number index assigned to each of the one or more text line blobs. At step 1208, the plurality of gap blobs may be clustered into one or more groups to determine a localized region of interest (ROI). At step 1209, the kernel size may be evaluated, and internal local text line distance may be extracted to identify the lines within each of the region of interest based on statistical calculation. At step 1210, the ROI may be verified based on the kernel size and a localized threshold for different regions within a page of the document. At step 1211, the text lines corresponding to localized ROI based conditionally merged from the gap blobs are considered. A configurable threshold of minimum number of lines in an ROI may be assigned for each conditionally merged ROI. At step 1212, the lines may be generated based on the background density (median points) in both the axes by localized blob ROI.

At step 1213, evaluation of the break points associated with the identified text blobs may take place. The break points may be determined on the basis of the black pixel density for e.g. (if the white pixel density=0, then the break point is collected else not). The median value in both horizontal and vertical direction may also be generated upon collection of the break point. Further, the median lines may also be generated corresponding to the median value evaluated. At step 1214, the median lines are used to generate the rows and columns and the coordinates of each cell's coordinates are appended in a list/dataframe format.

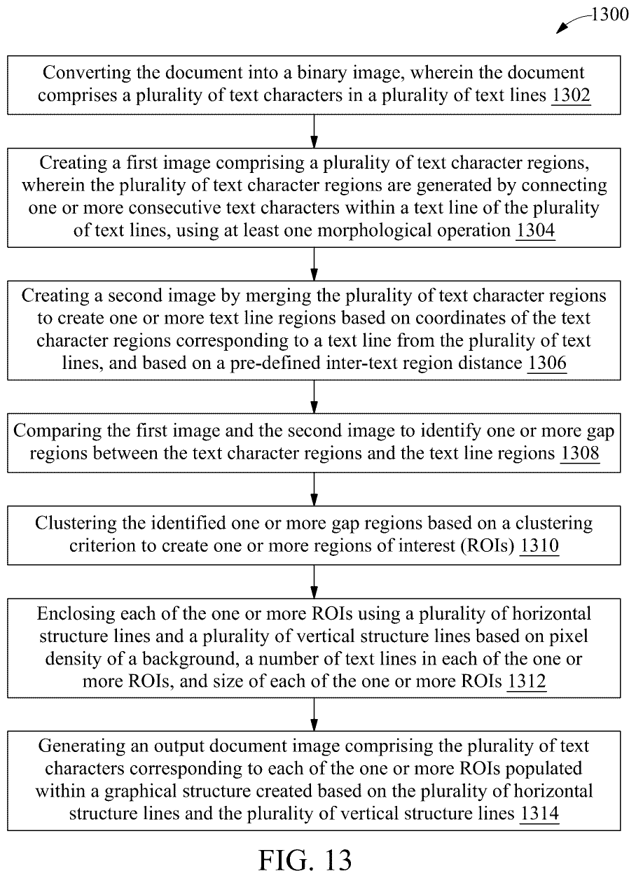

Referring now to FIG. 13, a flowchart of another method 1300 of extracting borderless structure from a document is illustrated, in accordance with an embodiment of the present disclosure. At step 1302, a document may be converted into a binary image, wherein the document comprises a plurality of text characters in a plurality of text lines. Converting may include changing the color of the background to black color and changing the color of the foreground to white color. At step 1304, a first image may be created including a plurality of text characters regions, wherein the plurality of text character regions are generated by connecting one or more consecutive text characters within a text line of the plurality of text lines, using at least one morphological operation.

At step 1306, a second image may be created by merging the plurality of text character regions to create one or more text line regions based on coordinates of the text character regions corresponding to a text line from the plurality of text lines and based on a pre-defined inter-text region distance. At step 1308, first image and the second image may be compared to identify one or more gap regions between the text character regions and the text line regions. At step 1310, the identified one or more gap regions may be clustered based on a clustering criterion (continuity of gaps blobs corresponding text-line index number) to create one or more regions of interest (ROIs). At step 1312, each of the one or more ROIs may be enclosed using a plurality of horizontal structure lines and a plurality of vertical structure lines based on pixel density of a background, a number of text lines in each of the one or more ROIs, and size of each of the one or more ROIs. At step 1314, a list containing the coordinate of each cell is available in dataframe/list format.

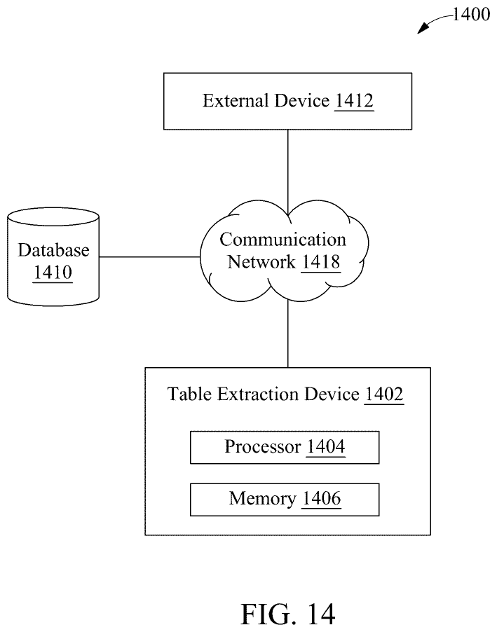

Referring now to FIG. 14, a block diagram of an environment 1400 for extracting borderless structure from a document is illustrated, in accordance with an embodiment of the disclosure. As shown in the FIG. 14, the environment 1400 may include a structure extraction device 1402, a database 1410, an external device 1412, and a communication network 1408. The structure extraction device 1402 may be communicatively coupled to the database 1410, and the external device 1412, via the communication network 1408.

The structure extraction device 1402 suitable logic, circuitry, interfaces, and/or code that may be configured to extract borderless structure from a document. The structure extraction device 1402 may include a processor 1404 and a memory 1406. The memory 1406 may store one or more processor-executable instructions which on execution by the processor 1404, may cause the processor 1404 to perform one or more steps for extracting borderless structure from a document. For example, the one or more steps may include receiving a document and converting the document into a binary image comprising a plurality of text characters and creating a plurality of text blobs by connecting text characters using at least one morphological operation to generate a first image. The one or more steps may further include merging the plurality of text blobs to create one or more text line blobs based on coordinates of the text blobs to generate a second image, comparing the first image and the second image to identify gaps between the text blobs and to further generate a third image comprising a plurality of gap blobs, and clustering the plurality of gap blobs into one or more groups to determine a localized region of interest (ROI). The one or more steps may further include identifying structure lines within the ROI based on background pixel density, and extracting text values from the identified text blobs and populating in the cells of a tabular structure determined.

The database 1410 may include suitable logic, circuitry, interfaces, and/or code that may be configured to store data received, utilized and processed by the Table extraction device 1402. Although in FIG. 14, the Table extraction device 1402 and the database 1410 are shown as two separate entities, this disclosure is not so limited. Accordingly, in some embodiments, the entire functionality of the database 1410 may be included in the Table extraction device 1402, without a deviation from scope of the disclosure. Additionally, the external device 1412 may include suitable logic, circuitry, interfaces, and/or code that may be configured to communicate with a user. The functionalities of the external device 1412 may be implemented in portable devices, such as a high-speed computing device, and/or non-portable devices, such as a server.

The communication network 1408 may include a communication medium through which the Table extraction device 1402, the database 1410, and the external device 1412 may communicate with each other. Examples of the communication network 1408 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the environment 1400 may be configured to connect to the communication network 1408, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

It is intended that the disclosure and examples be considered as exemplary only, with a true scope and spirit of disclosed embodiments being indicated by the following claims.

What is claimed is:

1. A method of extracting a borderless structure from a document, the method comprising:
converting the document into a binary image, wherein the document comprises a plurality of text characters in a plurality of text lines;
creating a first image comprising a plurality of text character regions, wherein the plurality of text character regions are generated by connecting one or more consecutive text characters within a text line of the plurality of text lines, using at least one morphological operation;
creating a second image by merging the plurality of text character regions to create one or more text line regions based on coordinates of the text character regions corresponding to a text line from the plurality of text lines, and based on a pre-defined inter-text region distance;
comparing the first image and the second image to identify one or more gap regions between the text character regions and the text line regions;
clustering the identified one or more gap regions based on a clustering criterion to create one or more regions of interest (ROIs);
enclosing each of the one or more ROIs using a plurality of horizontal structure lines and a plurality of vertical structure lines based on pixel density of a background, a number of text lines in each of the one or more ROIs, and size of each of the one or more ROIs; and
generating an output list of coordinates of one or more cells generated using the plurality of horizontal structure lines and the plurality of vertical structure lines which enclose each of the one or more ROIs.

2. The method of claim 1, wherein the plurality of text regions are identified based on a statistically calculated kernel size value.

3. The method of claim 1, further comprising:
assigning a serial number index to each of the plurality of text lines; and
mapping the plurality of gap regions of each one or more text line based on the assigned serial number index and the number of text lines in each of the one or more ROIs, wherein the plurality of gap regions are clustered to create an ROI from the one or more ROIs based on the mapping.

4. The method of claim 1, wherein enclosing each of the one or more ROIs comprises:
determining an inter-text line distance in each of the one or more ROIs based on a statistically calculated kernel size value; and
determining the plurality of gap regions in each of the one or more ROIs,
wherein the plurality of horizontal structure lines and the plurality of vertical structure lines are determined based on the density of pixel in each of the one or more ROIs.

5. The method of claim 1, wherein converting the document into the binary image comprises:
changing background color of the document to black color; and
changing foreground color of the document to white color.

6. A system for extracting a borderless structure from a document, comprising:
one or more processors;
a memory communicatively coupled to the processor, wherein the memory stores a plurality of processor-executable instructions, which, upon execution, cause the processor to:
convert the document into a binary image, wherein the document comprises a plurality of text characters in a plurality of text lines;
create a first image comprising a plurality of text character regions, wherein the plurality of text character regions are generated by connecting one or more consecutive text characters within a text line of the plurality of text lines, using at least one morphological operation;
create a second image by merging the plurality of text character regions to create one or more text line regions based on coordinates of the text character regions corresponding to a text line from the plurality of text lines, and based on a pre-defined inter-text region distance;
compare the first image and the second image to identify one or more gap regions between the text character regions and the text line regions;
cluster the identified one or more gap regions based on a clustering criterion to create one or more regions of interest (ROIs);
enclose each of the one or more ROIs using a plurality of horizontal structure lines and a plurality of vertical structure lines based on pixel density of a background, a number of text lines in each of the one or more ROIs, and size of each of the one or more ROIs; and
generate an output list of coordinates of one or more cells generated using the plurality of horizontal structure lines and the plurality of vertical structure lines which enclose each of the one or more ROIs.

7. The system of claim 6, wherein the plurality of text regions are identified based on a statistically calculated kernel size value.

8. The system of claim 6, wherein the processor is configured to:
assign a serial number index to each of the plurality of text lines; and
map the plurality of gap regions of each the one or more text line based on the assigned serial number index and the number of text lines in each of the one or more ROIs, wherein the plurality of gap regions are clustered to create an ROI from the one or more ROIs based on the mapping.

9. The system of claim 6, wherein the one or more ROIs are enclosed based on:
determination of an inter-text line distance in each of the one or more ROIs based on a statistically calculated kernel size value; and
determination of a statistically calculated value of the plurality of gap regions in each of the one or more ROIs,
wherein the plurality of horizontal structure lines and the plurality of vertical structure lines are determined based on the pixel density in each of the one or more ROIs and the statistically calculated value of the plurality of gap regions in each of the one or more ROIs.

10. The system of claim 6, wherein the conversion of the document into the binary image is based on:
change of background color of the document to black color; and
change of foreground color of the document to white color.

11. A non-transitory computer-readable medium storing computer-executable instructions for extracting a borderless structure from a document, the computer-executable instructions configured for:
converting the document into a binary image, wherein the document comprises a plurality of text characters in a plurality of text lines;
creating a first image comprising a plurality of text character regions, wherein the plurality of text character regions are generated by connecting one or more consecutive text characters within a text line of the plurality of text lines, using at least one morphological operation;
creating a second image by merging the plurality of text character regions to create one or more text line regions based on coordinates of the text character regions corresponding to a text line from the plurality of text lines, and based on a pre-defined inter-text region distance;
comparing the first image and the second image to identify one or more gap regions between the text character regions and the text line regions;
clustering the identified one or more gap regions based on a clustering criterion to create one or more regions of interest (ROIs);
enclosing each of the one or more ROIs using a plurality of horizontal structure lines and a plurality of vertical structure lines based on pixel density of a background, a number of text lines in each of the one or more ROIs, and size of each of the one or more ROIs; and
generating an output list of coordinates of one or more cells generated using the plurality of horizontal structure lines and the plurality of vertical structure lines which enclose each of the one or more ROIs.

12. The non-transitory computer-readable medium of claim 11, wherein the plurality of text regions are identified based on a statistically calculated kernel size value.

13. The non-transitory computer-readable medium of claim 11, the computer-executable instructions are configured for:
assigning a serial number index to each of the plurality of text lines; and
mapping the plurality of gap regions of each one or more text line based on the assigned serial number index and the number of text lines in each of the one or more ROIs, wherein the plurality of gap regions are clustered to create an ROI from the one or more ROIs based on the mapping.

14. The non-transitory computer-readable medium of claim 11, wherein the computer-executable instructions are configured to enclose each of the one or more ROIs, by:
determining an inter-text line distance in each of the one or more ROIs based on a statistically calculated kernel size value; and
determining the plurality of gap regions in each of the one or more ROIs,
wherein the plurality of horizontal structure lines and the plurality of vertical structure lines are determined based on the density of pixel in each of the one or more ROIs.

15. The non-transitory computer-readable medium of claim 11, wherein the computer-executable instructions are configured to convert the document into the binary image by:
changing background color of the document to black color; and
changing foreground color of the document to white color.
